(19) United States
(12) Patent Application Publication
(10) Pub. No.: US 2025/0134316 A1
(43) Pub. Date: May 1, 2025

(54) FOOD PROCESSOR ARRANGEMENT

(71) Applicant: KENWOOD LIMITED, Havant, Hampshire (GB)

(72) Inventor: Luke MATTHEWS, Havant (GB)

(21) Appl. No.: 18/834,019

(22) PCT Filed: Mar. 16, 2023
(86) PCT No.: PCT/GB2023/050640

§ 371 Date: Jul. 29, 2024

(30) Foreign Application Priority Data
Mar. 31, 2022 (GB) 2204732.8
Apr. 4, 2022 (LU) LU102926

(51) Int. Cl. A47J 43/07

(52) U.S. Cl. CPC A47J 43/0727; A47J 43/0716; A47J 2043/0738

(57) ABSTRACT

A food processing appliance comprises a base unit. A first attachment defining a first space therein is provided removably attachable to the base unit to carry out food processing in the first space in a first food processing configuration. A second attachment attachable to the base unit to carry out food processing in a second food processing configuration is also provided. The second attachment is securable within the first space in a storage configuration in which the first food processing attachment is attached to the base unit.

### FIELD

The present invention relates to a food processor arrangement, and in particular to a food processing appliance with more than one attachment, and a storage configuration therefore.

### BACKGROUND

As kitchens and houses are trending to be ever smaller, kitchen space is increasingly at a premium. As such it is desirable to provide compact food processing appliances. In particular, it is desirable that food processing appliances be sized, in at least a storage configuration, to fit within a standard kitchen drawer having a height of e.g., 300 mm or less.

Food processing appliances also tend to be sold with one or more attachments. These attachments tend to be lost or under-used over time as, once separated from the main appliance they are mis placed or stored separate to the main appliance and forgotten about.

The present invention aims to at least partially ameliorate the above-described problems of the prior art.

### SUMMARY OF THE INVENTION

According to the invention there is provided food processing appliance comprising: a base, first and second food processing attachments arranged to be interchangeably mounted to the base for food processing in either a first or a second configuration of the appliance respectively, the appliance having a storage configuration in which the first attachment is mounted to the base, and the second attachment is at least partly nested or accommodated within the first attachment.

Thus the appliance may be stored in a compact configuration, which is more easy and convenient for a user.

For example, the first and second attachments may each comprise a container providing a processing space, and a food processing tool provided in the processing space, in which to tool may be detachable, the container(s) being attachable to the base for performing different food processing operations. Conveniently, the second attachment is configured such that the tool or tools may remain, preferably attached, in the storage configuration, in which case they are preferably not in contact with any other component or each other, which can avoid damage. This can further improve utilisation of space and enhance storage.

The first and second attachments may each comprise a container with a removable lid. Preferably, in the storage configuration, the second attachment is received at least partly within the container or processing space of the first attachment, and extends partly out of the container such that it can be grasped by a user for removal. The first attachment may comprise a first lid which is attachable to the second container in the storage configuration, and optionally the second container comprises a second lid which is nested with the second attachment in the storage configuration, optionally in a recess of the second attachment. The first lid can close the recess. Thus all of the components of the first and second attachment can be secured together in a compact manner. This may facilitate avoiding loss of any of the components.

The appliance preferably comprises a safety arrangement or interlock system configured to permit operation of the appliance, for example by the energizing of a component of the base unit, preferably a motor, when the first lid is secured on the first attachment in the first food processing configuration and alternatively when the second lid is secured on the second attachment in the second food processing configuration, and prevent operation of the appliance when the first lid is attached on the second attachment, and optionally when the second lid is nested with the second attachment, in the storage configuration.

Conveniently, the second attachment is positioned in a reverse or inverted orientation in the storage configuration relative to the food processing configuration. Thus the profile of the first container may widen from the base, whilst the profile of the second container may narrow from the base, such that it fits within the first container when inverted, for example with just a base part extending out of the first container above the top of the container. The base part of the second attachment may be configured to correspond in size with the rim of the first container, so as to close the first container.

The height of the appliance in the storage configuration is preferably equal to or less than 300 mm. This makes it of a size that may be stored in, for example, a typical kitchen drawer.

The food processing operation of the first food processing configuration preferably differs in type to that of the food operation of the second food processing configuration. This can enable more than one kind of food processing thus potentially increasing the utility of the appliance.

The food processing of the first food processing configuration may optionally be chopping. Chopping can be a useful food processing process for the consumer.

The food processing of the second food processing configuration is preferably grinding. Grinding too can be a useful process for the consumer.

The first lid preferably comprises an ingredient dropper. This can increase the utility of the appliance. For example, the ingredient dropper may comprise an ingredient reservoir, which may have an open top for receiving ingredients, communicating with an aperture in the lid for allowing the passage of drops of the ingredient.

The ingredient dropper is preferably configured to act as a handle for the lid, preferably by being elongate and/or trough-shaped, optionally extending from an upper surface of the lid This can make locking and unlocking of the lid easier.

The ingredient dropper preferably has a length of at least a radius of the lid. This can increase capacity and mechanical advantage.

The ingredient dropper optionally comprises a wall having a height above the lid of at least 15 mm, and more preferably 20 mm, and more preferably still 30 mm. This can make it easily graspable by the average human hand.

In another aspect of the invention, a lid for a food processor is disclosed comprising an ingredient dropper, the ingredient dropper being shaped and configured to act as a handle for the lid, preferably by being elongate and/or trough-shaped. This gives the combined advantage of an ingredient dropper and a handle without having to provide these components separately.

The ingredient dropper preferably has a length of at least a radius of the lid, preferably extending from a periphery of the lid to a centre of the lid. This can give better mechanical advantage for opening and closing the lid.

Preferably the ingredient dropper comprises a wall having a height above the lid of at least 15 mm, and more preferably 20 mm, and more preferably still 30 mm. This can improve gripability

Preferably, the ingredient dropper extends beyond a peripheral flange of the lid. This can improve gripability.

Optionally, the lid comprises a food-safe and/or dishwasher-safe and/or transparent material. This can increase utility and safety of the lid.

According to another aspect of the present invention, there is provided a food processing appliance comprising a base unit, a first attachment defining a first space therein removably attachable to the base unit to carry out food processing in the first space in a first food processing configuration, and a second attachment attachable to the base unit to carry out food processing in a second food processing configuration. The second attachment is securable within the first space in a storage configuration in which the first food processing attachment is attached to the base unit.

The above-described appliance has the advantage that the space is used more efficiently and thus storage of the appliance is made more easy and convenient.

Optionally, the first attachment can comprise a first tool located, preferably releasably, within the first space for carrying out a first food processing activity in the first food processing configuration. The utility of the appliance may thus be enhanced.

Preferably, the second attachment defines a second space within it. This space may be used for food processing purposes or storage.

In another optional configuration, the second attachment comprises a second tool located within the second space for carrying out a second food processing activity in the second food processing configuration. This may increase the utility of the appliance.

The second food processing attachment may optionally be configured to accommodate the first tool within the second space in the storage configuration, preferably with the first tool still attached directly to the first attachment as in the first food processing configuration. This may further improve utilisation of space and enhance storage.

In the storage configuration, the first tool and the second tool preferably do not contact each other. The second tool may preferably remain attached directly to the second attachment. This can help prevent damage and wear to the tools due to tools clashing.

The appliance may optionally further comprise a first lid configured to be releasably attachable to the first attachment to substantially close the first space in the first food processing configuration, and releasably attachable to the second attachment in the storage configuration. This can be an efficient storage configuration and may help prevent the lid being lost in the storage configuration.

The appliance may also optionally have a second lid, configured to be attachable to the second attachment to substantially close the second space in the second food processing configuration, and to be locatable in a cavity of the second attachment in the storage configuration. Again, this is potentially an efficient storage configuration, and may prevent the second lid being lost.

In a preferable configuration, the first lid is further configured to substantially close the cavity to secure the second lid therein in the storage configuration. This can further prevent the second lid being lost.

Preferably, the appliance comprises an interlock system configured to permit energizing of a component of the base unit, preferably a motor, when the first lid is secured on the first attachment in the first food processing configuration, and prevent energizing the of component of the base unit when the first lid is attached on the second attachment in the storage configuration. Unnecessary and/or dangerous activation of the component may thus be prevent.

The interlock mechanism may preferably be further configured to permit energizing of the component when the second lid is attached to the second food attachment in the second food processing configuration, and prevent energizing of the component when the second lid is located in the cavity in the storage configuration. This may also help prevent unnecessary and/or dangerous activation.

The component can optionally be a motor. This can allow the driving of tools by the appliance.

Any apparatus feature as described herein may also be provided as a method feature, and vice versa. As used herein, means plus function features may be expressed alternatively in terms of their corresponding structure, such as a suitably programmed processor and associated memory, for example.

The invention extends to methods, system and apparatus substantially as herein described and/or as illustrated with reference to the accompanying figures.

The invention extends to any novel aspects or features described and/or illustrated herein. Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

Furthermore, features implemented in hardware may generally be implemented in software, and vice versa. Any reference to software and hardware features herein should be construed accordingly.

The invention described here may be used in any appliance, such as a kitchen appliance, and/or as a stand-alone device. This includes any domestic food-processing and/or preparation appliance, including both top-driven appliances (e.g., stand-mixers) and bottom-driven appliances (e.g., food processors). It may be implemented in heated and/or cooled appliances. The invention may also be implemented in both hand-held (e.g., hand blenders) and table-top (e.g., blenders) appliances. It may be used in an appliance that is built-in to a work-top or work surface, or in a stand-alone device. The invention can also be provided as a stand-alone device, whether motor-driven or manually powered.

Whilst the invention has been described in the field of domestic food processing and preparation appliances, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances. Any reference to “food”, “beverage” (or similar language) herein may be replaced by such working mediums.

“Food processing” as described herein should be taken to encompass chopping, whisking, stirring, kneading, mincing, grinding, shaping, shredding, grating, cooking, freezing, making ice-cream, juicing (centrifugally or with a scroll), or other food-processing activities involving the physical and/or chemical transformation of food and/or beverage material by mechanical, chemical, and/or thermal means. “Food processing attachment” encompasses any attachable component configured, for example on rotation and/or energising, to carry out any of the previously described food processing tasks.

As used herein, the term “removable attachment” (and similar terms such as “removably attachable” and “reversibly attachable”), as used in relation to an attachment between a first object and a second object, preferably connotes that the first object is attached to the second object and can be detached (and preferably re-attached, detached again, and so on, repetitively), and/or that the first object may be removed from the second object without damaging the first object or the second object; more preferably the term connotes that the first object may be re-attached to the second object without damaging the first object or the second object, and/or that the first object may be removed from (and optionally also re-attached to) the second object by hand and/or without the use of tools (e.g. screwdrivers, spanners, etc.). Mechanisms such as a snap-fit, a bayonet attachment, and a hand-rotatable locking nut may be used in this regard.

As used herein, the term “processing” preferably connotes any action relating to or contributing towards transforming products into foodstuff, or transforming foodstuff into a different form of foodstuff, including—as examples—applying mechanical work (e.g. for cutting, beating, blending, whisking, dicing, spiralizing, grinding, extruding, shaping, kneading etc.) and applying heat or cold. “Food” and “foodstuff” as used herein can include beverages and frozen material and material used in creating them (e.g., coffee beans).

### BRIEF DESCRIPTION OF DRAWINGS

One or more aspects will now be described, by way of example only and with reference to the accompanying drawings having like-reference numerals, in which:

FIG. 1a is a side-on view of the exterior of the food processor appliance of the present invention in a storage configuration;

FIG. 1b is a side-on view of the exterior of the food processor of FIG. 1a in a food processing configuration;

FIG. 1c is a side-on view of the exterior of the food processor of FIG. 1a in a grinding configuration;

FIG. 2a is a side-on, cut-away view of the food processor appliance of FIG. 1a;

FIG. 2b is a side-on, cut-away view of the food processing appliance of FIG. 1b;

FIG. 2c is a side-one, cut-away view of the food processing appliance of FIG. 1c;

FIG. 3 is a side-on, exploded view of the food processing appliance of FIG. 1a;

FIG. 4 is a perspective view of the food processing appliance of FIG. 1a; and,

FIG. 5 is a side-elevation view of the food processing appliance of FIG. 1a,

FIG. 6 shows perspective views of a spatula for use with the food processing appliance, in folded and unfolded states, and

FIG. 7 is a perspective view from above, broken away, of the spatula of FIG. 6 fitted to the appliance lid.

### SPECIFIC DESCRIPTION

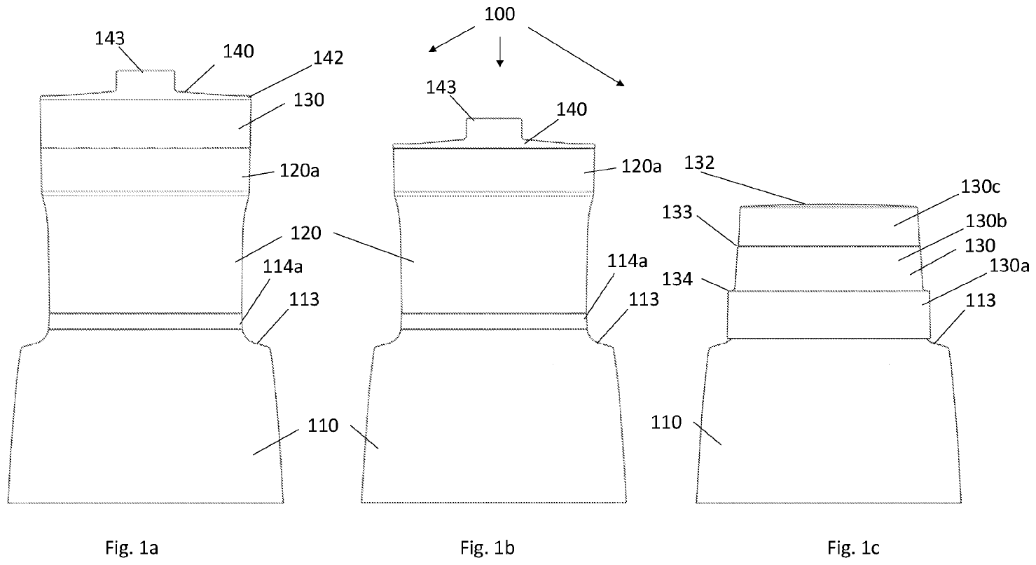

Referring to FIGS. 1a, 1b and 1c, a food processing appliance 100 can be assembled into a storage configuration, a first processing configuration or a second processing configuration. First and second attachments 120, 130 may be mounted or attached to a base 110 interchangeably, to provide the first and second processing configurations respectively, In the storage configuration, the first attachment may be mounted to the base in the same way as for processing.

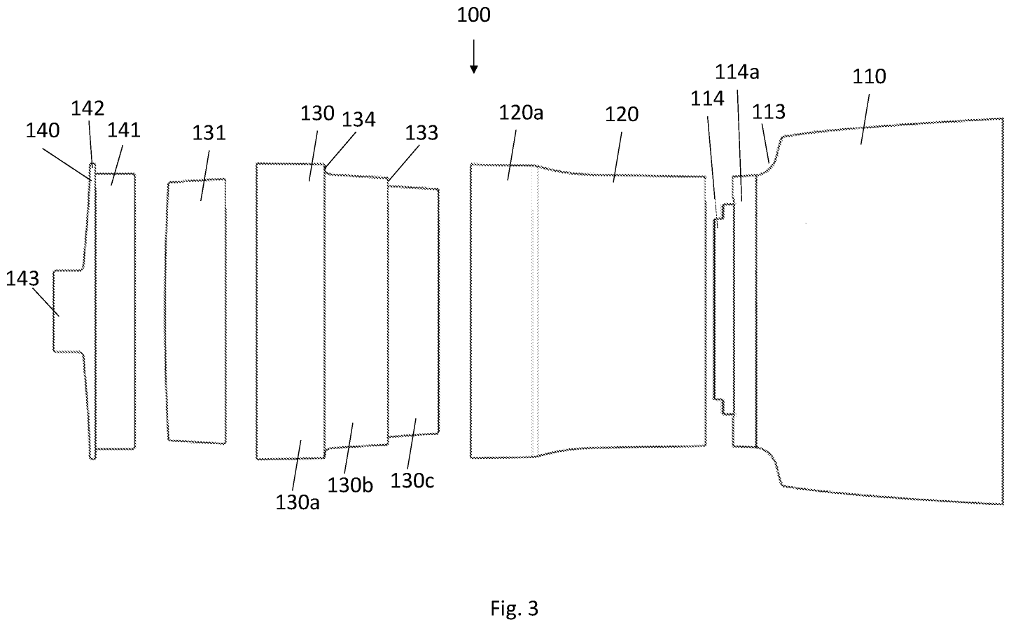

FIGS. 1a, 2a, 3, and 4 show a food processing appliance 100 assembled in a storage configuration. The food processing appliance comprises a base in the form of a base unit 110. A motor 111 is housed within the base unit 110, that can out-put drive via a shaft 112 through an upper surface 114. A first food processing attachment comprising a container 120 is arranged to be attachable to the upper surface 114 of the base unit 110 by e.g., latches and/or a bayonet fixing. The container 120 has a lower narrower section and an upper wider section 120a which opens at an end 124 opposite to that which connects to the base unit 110. The container 120 encloses a food processing space 125 within which food can be processed. A food processing tool 121 extends into the food processing space 125 from the bottom of the container 120, and connects to the shaft 112 to receive drive from it.

The food processing tool 121 can be permanently fixed to the container 120 or removably attachable to it via, for example, a bayonet fixing, and has blades 121a and 121b that can be of differing length—for example the lower blades 131a may be longer than the shorter blade 121b. The food processing tool 121 may be a chopping tool, that is, a tool that is designed to cut food to separate it into smaller fragments. To enable handling of the tool 121 with less risk of touching the blades 121a/121b, the tool 121 may have a finger-grip 121c provided at its upper end.

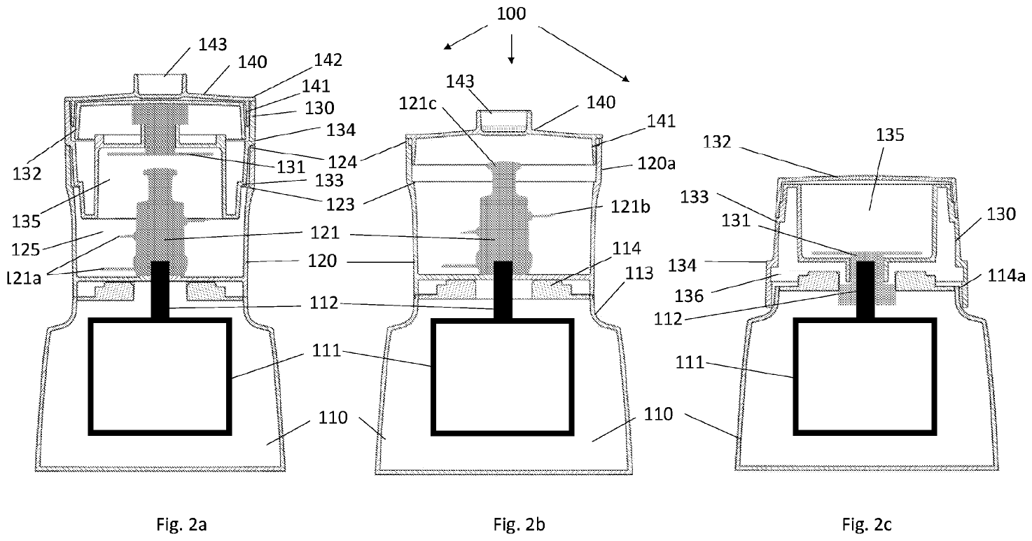

At the top of the food processing appliance 100 assembled in a storage configuration in FIGS. 1a and 2a, at least partially inserted into the upper opening of the container 120 in an inverted orientation, is a second food processing attachment in the form of a grinder attachment 130. The outer housing of the grinder 130 consists of concentric axially-extending sections 130a, 130b, and 130c that are successively smaller in radial extent, so as to form shoulders 134 and 133 between the sections 130a and 130b, and 130b and 130c. The shoulder 133 that is located lowermost (i.e., closest to the base 110) when the grinder 130 is inserted into the container 120 in the inverted configuration of FIGS. 1a and 2a rests on an internal ledge 123 within the container 120 at the transition point between the narrower and wider section 120a of the container 120. The shoulder 134 that is further away from the base 110 than the lowermost shoulder 133 when the grinder 130 is inserted into the container 120 rests on the lip formed at the end 124 of the container 120. In this way the grinder 130 is stored at least partially within the container 120 thus achieving a compact storage configuration. The grinder 130 is optionally latched within the container 120 using a suitable latching arrangement such as a bayonet fixing, so that it is prevented from accidentally falling out.

The interaction of the end 124, and ledge 123 with the shoulders 133 and 134 locates the grinder 130 within the container 120 without it falling entirely into the container 120 which would make it more difficult to extract from the container 120. This allows the food processing tool 121 to remain attached to the food processing container 120 during storage as it is accommodated within the grinding space 135. It can also prevent the food processing tool 121 coming into contact with the grinding tool 131 of the grinder 130, which might cause damage to one or both of the tools 121 and 131. Instead the tool 121 extends into an internal grinding space 135 of the grinder 130 without coming into contact with the grinding tool 131. As it is not necessary to detach the food processing tool 121 from the container 120 for storage, the risk of injury whilst handling the sharp tool 121 is also reduced.

The grinder 130 also has a cavity 136 (preferably annular) in the end opposite to that in which the grinding space 135 opens. In the storage configuration of FIGS. 1a and 2a the cavity 136 opens towards the opening of the end 124 of the container 120 and can receive the grinder lid 132. The grinder lid 132 is located so as to close the grinding space 135 when the grinder 130 is in use as shown in FIGS. 1c and 2c, but in the storage configuration of FIGS. 1a and 2a the grinding space 135 is left open so that the food processing tool 121 can extend into it. The grinder lid is optionally latching to the grinder 130 within the grinding space 135 using e.g., bayonet fixings.

The cavity 136 can also receive the a processor lid 140 so as to close the cavity 136. The lid 140 may optionally be latchingly received in cavity 136 using, e.g., bayonet fixings, to prevent it falling out of the cavity 136, and to hold the grinder lid 132 within the cavity 136 if it is not fixed therein. This is achieved by placing the lid 140 so that its axially-protruding skirt 141 extends into the cavity 136 and surrounds the grinder lid 132 thus helping to retain it, and so that its radially-protruding flange 142 rests on the lip of the opening of the cavity 136.

By storing the lids 132 and 140 on/in the cavity 136, and by allowing the tool 121 to extend into the grinding space 135 in the storage configuration, a particularly compact storage configuration in which all components of the appliance 100 are stored together in a single place (and thus less likely to be lost/forgotten about) is achieved.

In the storage configuration of FIGS. 1a and 2a the height of the appliance is preferably less than 300 mm. This ensures that it can fit within a standard kitchen drawer/cupboard for storage without disassembling. Preferably the height of the appliance 100 in the food processing configuration of FIGS. 1b and 2b, and that in the grinding configuration of FIGS. 1c and 2c, is also less than 300 mm.

The appliance 100 can also be configured in a first food processing configuration shown in FIGS. 1b and 2b. In this configuration the grinder 130 is removed from the container 120 making the food processing tool 121 available to carry out food processing in the food processing space 125. In this configuration the processor lid 140 is received in the end 124, so that the flange 142 rests on the end 124 whilst the skirt 141 fits within it. The lid 140 is preferably latched to the container 120 using e.g., bayonet fixings.

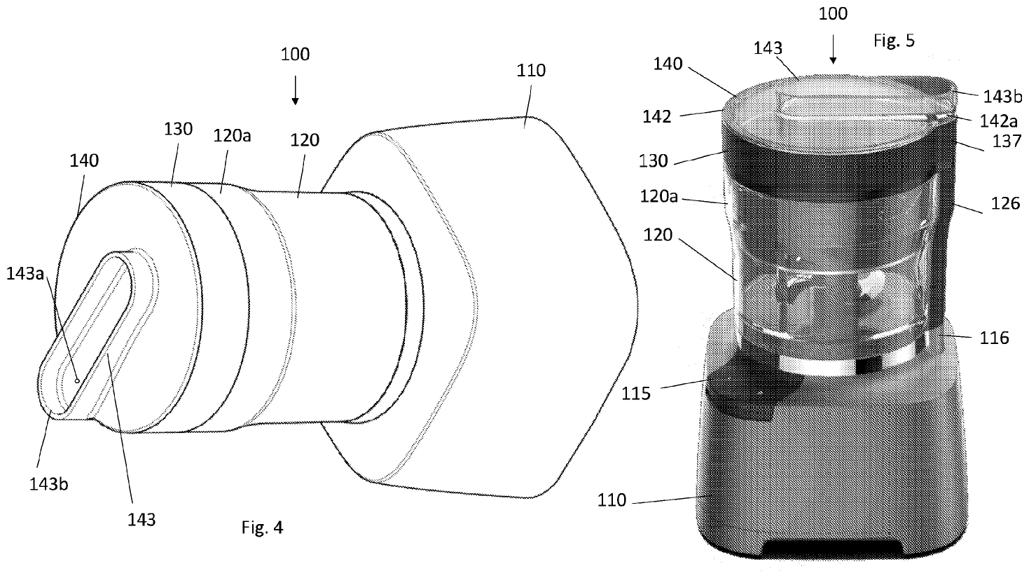

The lid 140 includes an ingredient dropper 143 on its upper surface which can be seen in FIGS. 4 and 5. This is an ingredient container or reservoir with an opening into which ingredients can be placed, such as oil, that then can drop slowly from the ingredient dropper 143 through a hole 143a in the lid 140 into the food processing space 125 during food processing. Ingredients can thus be slowly added to food during processing, which is useful during making e.g., mayonnaise. The hole 143a is preferably located off-centre relative to the lid 140 as otherwise the ingredients dropping from it drop directly on to the tool 121 rather than into the ingredients it is processing. The ingredient dropper 143 may be e.g., trough-shaped (e.g., elongate with a width sufficiently narrow to be gripped by the average human hand) and extend over a significant part of the lid 140 (e.g., may have a length that is roughly equal to or more than a radius of the lid, and extend from a periphery of the lid towards the centre). The ingredient dropper 143 may also extended radially outwards from the flange of the lid 140 to form an easily-grippable portion for easier accessibility. The dropper 143 may optionally have a raised wall 143b with a height of e.g., 10 mm or more, more preferably 20 mm or more, and more preferably still 30 mm or more, defining the ingredient container, so as to provide a high enough wall to grip and push on. This shape and/or wall-height allows the ingredient dropper 143 to double as a handle that can be used for holding the lid and turning it during e.g., latching and unlatching of the lid 140 from the container 120.

FIGS. 1c and 2c show the appliance 100 in a food grinding configuration. In this configuration the container 120 is removed from the base 110 and the grinder attachment 130 is place on the base 110 instead. The grinder 130 is attached such that the upper surface 114 of the base 110 is inserted into the cavity 136, such that the grinder 130 surrounds the upper surface 114, abuts on a collar 114a directly below the upper surface 114. and rests on a shoulder 113 of the base 110 below the collar. The grinder 130 is preferably latchable to the collar 114a via e.g., bayonet fixings to secure it to the base 110. In this food grinding configuration the food grinding space 135 faces away from the base 110 making it accessible from above. Food to be ground can be inserted into the food grinding space 135 where the food grinding tool 131 (which can be a relatively blunt compared to tool 121, rotary tool that tends to smash/smear/grind the food into a paste or powder rather than just chopping it) is driven by the shaft 112 to grind food. Once the food is placed within the grinding space 135, the grinder lid 132 can be attached via e.g., latches/bayonet fixings to cover and seal the grinding space 135, preventing food from being sprayed out of (or the user's hand from entering) the grinding space 135.

FIG. 5 shows the interlock arrangement of the appliance 100. This interlock arrangement prevents the motor 111 of the base 110 from being energised to carry out food processing or grinding except when the food processing container 120 is attached to the base 110 and the lid 140 properly attached/latched to the container 120 so at to substantially seal the food processing space 125. Additionally the interlock arrangement permits the motor 111 to be energised when the grinding attachment 130 is properly attached/latched to the base 110 and the grinder lid 132 is properly attached so as to seal the grinding space 135.

This is achieved by having a tab portion 142a of the flange 142 of the lid 140 actuate a switch 116 located in the base 110 when the lid 140 is correctly placed on the container 120 and rotated to the right position. This actuation which permits activation of the motor 111 using the controls 115 of the base 110. The actuation is achieved by the tab 142a pushing a push-rod within a tube 126 extending down the side of the container 120 from the tab 142a to the switch 116, which then in turn pushes the switch 116. The push-rod within the tube 126 is spring-loaded so that it normally protrudes from the end 124 of the container 120 opposite to that which attached to the base 110, unless it is pushed downwards by the tab 142a in which case it extends to contact the switch 116. The push road need not be straight/rigid, but can be bent/flexible to get around any bends within the tube 126. Actuation of the switch 116 when the grinder 130 is used and the lid 132 is correctly attached to it is achieved in similar fashion by the lid 132 pushing a similarly spring-loaded push-rod within the grinder tube 137.

Other interlock arrangements are possibly, including reed-switch/magnet arrangements, electrical circuits which are completed by an element in the lid 140 when it is correctly position, etc.

However, in order to avoid unnecessary and potentially dangerous energising of the motor 111 when the appliance 100 is in the storage configuration, neither the processor lid 140 nor the grinder lid 132 should be able to actuate the switch 116 when the appliance 100 is in the storage configuration. This is achieved by interposing the grinder tube 137 of the grinder 130 between the tab 142a and the tube 126, and by making it so that the push rod of the grinder tube 137 cannot actuate the push-rod of the tube 126. The push-rod of the grinder tube 137 can for example be not aligned (e.g., located at a different radial or rotational location in the storage configuration) with that of the tube 126 to prevent one actuating the other. Obviously when the grinder lid 132 is located within the cavity 136 and under the lid 140 it cannot actuate the push-rod of the grinder tube 137.

The drive shaft 112 may optionally be a concentric dual-drive shaft, having two (or more than two) concentric drive-shafts rotating at different speeds. The grinder tool 131 and food processor tool 121 may connect to different concentric drive shafts of the drive shaft 112 to be driven at different speeds.

The lids 140 and 132 are preferably transparent, for example they may be made of glass or a transparent plastic. This enables the user to view the processing of food within their respective attachments 120 and 130. The tools 121 and 131 are preferably food-safe and dish-washer safe, for example being made of stainless steel and thermo-plastic polymers such as Nylon™. Similarly the attachments 120 and 130, and the lid 140 are preferably food-safe and dishwasher-safe such as, for example, co-polymers such as Tritan™.

“Food safe” in this context means any substance that does not shed substances harmful to human health in clinically significant quantities if ingested. For example, it should be BPA-free.

“Dishwasher safe” means that it should be physically and chemically stable during prolonged exposure to the conditions prevailing within a dishwasher machine. For example it should be able to withstand exposure to a mixture of water and a typical dishwasher substance (e.g., washing with Fairy™ or Finish™ dishwasher tablets and water, at temperatures of 82 degrees centigrade for as long as 8 hours without visibly degrading (e.g., cracking)).

Additionally to, or in place of the motor 111, the base unit 110 may include a heating and/or cooling element for heating and/or cooling food within the attachments 120 and 130. The attachments 120 and 130 may be driven by their own internal motors, and may include their own internal heating and/or cooling elements. The attachments 120 and 130 may perform different food processing tasks to chopping and grinding, including juicing, mixing, blending, cooking, etc. The base unit 110 may optionally be a stand-mixer-type device where tools are driven top-down rather than bottom-up.

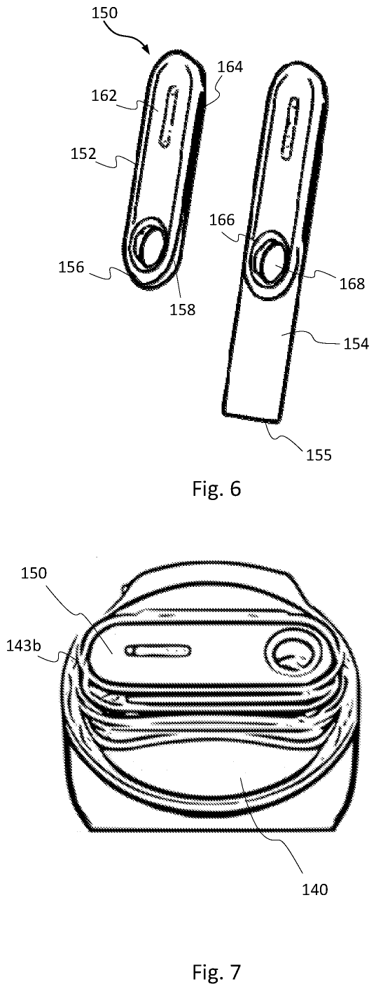

Referring to FIGS. 6 and 7, the ingredient dropper 143 reservoir of the lid 140 may provide a storage space for a food processing tool for use with the appliance, such as a spatula, which is conveniently a foldable tool.

As shown in FIG. 6, a folding spatula 150 may be provided for use with the appliance. The spatula comprises a handle body 152 and a substantially flat spatula blade 154. The body 152 is shaped and configured to be housed within the raised wall 143b defining the reservoir of the ingredients dropper 143. The handle body 152 may have a shape in plan view which corresponds with the shape of the reservoir. For example, the handle 152 may be elongate lozenge shaped, and may have a thickness which is less than the height of the walls 143b of the dropper 143 reservoir, in order to fit within the reservoir.

A cavity 158 for accepting the blade 154 is formed between upper and lower faces 162, 164 of the handle body 152. The body 152 is attached at one end 156 to a proximal end of the blade 154, in a manner such that the blade 154 may be folded into the cavity 158 so as to be housed within the handle 152. For example, the blade may comprise a pivot bearing 166 which engages with an aperture 168 of the handle 152, and the blade 154 may have a width which corresponds with the width of the handle 152, or is smaller. Conveniently, the blade 154 has a blunt or squared off distal end 155.

Thus the spatula 150 may be stored in the ingredients dropper 143 reservoir, with the blade 154 housed within the handle 152. In use, the spatula 150 is removed from the reservoir and the blade 154 manipulated so as to be folded out of the handle 152. The spatula 150 may then be used for activities related to processing, such as scraping ingredients from the sides of the container 120.

As used herein, the term “removable attachment” (and similar terms such as “removably attachable”, “releasably attachable”), as used in relation to an attachment between a first object and a second object, preferably connotes that the first object is attached to the second object and can be detached (and preferably re-attached, detached again, and so on, repetitively), and/or that the first object may be removed from the second object without damaging the first object or the second object; more preferably the term connotes that the first object may be re-attached to the second object without damaging the first object or the second object, and/or that the first object may be removed from (and optionally also re-attached to) the second object by hand and/or without the use of tools (e.g. screwdrivers, spanners, etc.). Mechanisms such as a snap-fit, a bayonet attachment, and a hand-rotatable locking nut may be used in this regard.

Each feature disclosed in the description, and (where appropriate) the claims and drawings may be provided independently or in any appropriate combination.

Reference numerals appearing in the claims are by way of illustration only and shall have no limiting effect on the scope of the claims.

1-25. (canceled)

26. A food processing appliance comprising:
a base, first and second food processing attachments arranged to be interchangeably mounted to the base for food processing in either a first or a second configuration of the appliance respectively,
the appliance having a storage configuration in which the first attachment is mounted to the base, and the second attachment is at least partly nested within the first attachment.

27. The food processing appliance as claimed in claim 26, in which the first and second attachments each comprise a container providing a respective food processing space, and a food processing tool, optionally in which the or each tool is detachable.

28. The food processing appliance as claimed in claim 27, in which at least one tool is accommodated in at least one of the processing spaces, optionally attached to at least one of the first and second attachments, in the storage configuration.

29. The food processing appliance as claimed in claim 27, in which a tool is attached to both attachments in the storage configuration, preferably wherein the tools are not in contact with each other.

30. The food processing appliance as claimed in claim 26, wherein the first and second attachments each comprise a container with a removable lid, optionally arranged to close the processing space.

31. The food processing appliance as claimed in claim 30, wherein, in the storage configuration, the second attachment is received within the container of the first attachment, and extends partly out of the container, optionally closing the or each processing space.

32. The food processing appliance as claimed in claim 30, wherein the first attachment comprises a first lid which is attachable to the second container in the storage configuration, optionally closing the or each processing space.

33. The food processing appliance as claimed in claim 30, wherein the second container comprises a second lid which is nested with the second attachment in the storage configuration, optionally in a recess of the second attachment, the recess optionally being closable by the first lid.

34. The appliance of claim 30, wherein the appliance comprises a safety arrangement configured to permit operation of the appliance when the first lid is secured on the first attachment in the first food processing configuration and when the second lid is secured on the second attachment in the second food processing configuration, and prevent operation of the appliance when the first lid is attached on the second attachment, and optionally when the second lid is nested with the second attachment, in the storage configuration.

35. The appliance of claim 34, where the safety arrangement is configured to permit or prevent operation of the appliance by permitting or preventing energizing of a component of the base, preferably wherein the component is a motor.

36. The food processing appliance as claimed in claim 26, wherein the second attachment is positioned in an inverted orientation in the storage configuration relative to the food processing configuration.

37. The appliance of claim 26 wherein a height of the appliance in the storage configuration is equal to or less than 300 mm.

38. The appliance of claim 26 where the food processing operation in the first configuration differs in type to that of the food processing operation in the second food processing configuration, optionally wherein the food processing operation in the first food processing configuration is chopping, and/or wherein the food processing operation in the second food processing configuration is grinding.

39. The appliance of claim 26, wherein the first attachment comprises a first lid which comprises an ingredient dropper, optionally having a reservoir for ingredients, the reservoir communicating with an aperture for dispensing the ingredient into the first container.

40. The appliance of claim 39, wherein the ingredient dropper is configured to act as a handle for the lid, preferably being elongate and/or trough-shaped and extending from the upper surface of the lid, optionally wherein the ingredient dropper has a length of at least a radius of the lid, preferably extending from an edge of the lid to a centre of the lid.

41. The appliance of claim 40, wherein the ingredients dropper is configured to house a food processing tool, preferably a spatula, optionally in a folded configuration, optionally wherein the ingredient dropper extends from the upper surface of the lid by at least 15 mm, and more preferably 20 mm, and more preferably still 30 mm.

42. A lid for a food processing appliance, comprising an ingredient dropper, the ingredient dropper being shaped and configured to act as a handle for the lid, preferably being elongate and/or trough-shaped.

43. The lid as claimed in claim 42, wherein the ingredient dropper comprises a reservoir for ingredients extending from an upper surface of the lid, and an aperture communicating with the underside of the lid for dispensing ingredients in drops, optionally wherein the ingredient dropper has a length of at least a radius of the lid, preferably extending from a periphery of the lid to a centre of the lid.

44. The lid of claim 43, wherein the ingredient dropper comprises a wall having a height above the lid of at least 15 mm, and more preferably 20 mm, and more preferably still 30 mm, and/or wherein the ingredient dropper extends beyond a peripheral flange of the lid, and/or wherein the ingredient dropper is configured to house a food processing tool, optionally a spatula, preferably in a folded configuration.

45. The appliance of claim 26 comprising a food-safe and/or dishwasher-safe and/or transparent material.
